(19) United States
(12) Patent Application Publication
(10) Pub. No.: US 2003/0096573 A1
(43) Pub. Date: May 22, 2003

(54) Forward and return direction payload architecture using equivalent and shared components and subassemblies

(76) Inventors: Raymond M. Nuber, Rancho Palos Verdes, CA (US); William F. Courtney, Long Beach, CA (US); Christopher E. Kelly, Manhattan Beach, CA (US); Terrence R. Smigla, Pacific Palisades, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 09/991,461

(22) Filed: Nov. 20, 2001

(51) Int. Cl. H04B 7/185

(52) U.S. Cl. 455/12.1; 455/427

(57) ABSTRACT

A communications satellite system 100 is provided that comprises a communications satellite 101, at least one user terminal 204 and at least one gateway terminal 202. The communications satellite 101 conveys communication signals between the user terminal 204 and the gateway terminal 202. The communications satellite system 100 includes a forward communication path 200 and a return communication path 300 through the communications satellite 101 between the user terminal 204 and the gateway terminal 202. At least one equivalent signal component is located in both the forward communication path 200 and return communication path 300 and operates on the communication signals. The equivalent signal component has substantially the same operating range in both the forward communication path 200 and return communication path 300 for at least one operating characteristic.

### BACKGROUND OF THE INVENTION

The present invention generally relates to communications satellite systems. In particular, the present invention relates to a communications satellite system that processes forward and return communications signals.

A typical communications satellite system includes a satellite which coordinates communications between various points on the earth's surface. The communications satellite system may provide service, for example, to a very small aperture terminal (VSAT) communication network. The VSAT communication network may be comprised of multiple gateway terminals and user terminals, each of which communicates directly with the satellite and utilizes a separate communication path.

Communications satellite systems utilize multiple components to receive, process and transmit the signals between the gateway terminals and the user terminals. In general, a satellite utilizes an antenna that may be shared to transmit information simultaneously to both gateway terminals and user terminals. However, satellites utilize components to receive, process and transmit signals in a forward direction (e.g. gateway terminal to user terminal) that are separate and distinct from the components used to receive, process and transmit signals in a return direction (e.g. user terminal to gateway terminal).

A VSAT communication network may be used for commercial applications, such as a retailer to provide communication capability between a chain of stores or gas stations. For example, each gas station may be a user terminal and one central system may be a gateway terminal. Another example of a VSAT communication network may be an internet service provider (ISP). The ISP provides internet access to many user terminals. The amount of information sent from the user terminals to the gateway terminal may vary considerably as users log on and off the system.

In the past, the gateway terminal configurations have been proposed that transmit a large volume of information in a forward direction to many user terminals, while the user terminals transmit a much lower volume of information in the return direction to the gateway terminal. However, the user terminals in VSAT communication networks are experiencing a need to communicate increasing amounts of information to the gateway terminal. This increase may be due, for example, to a larger number of people accessing the internet and the increased use of commercial applications utilizing remote monitoring and communication.

In order to process the increased volume of signals from the user terminals to the gateway terminals without decreasing the level of service provided, a communications satellite system operating in accordance with a conventional design may need to increase the quantity of hardware that receives, processes and transmits signals in the return direction, thus increasing the complexity of the system, the power requirements, and the overall cost. This is not desirable. Instead, a means of reducing cost while improving capacity and efficiency is desired.

Thus, a need exists to better utilize available satellite hardware to reduce cost and improve capacity and efficiency while not compromising the level of service provided.

### SUMMARY OF THE INVENTION

In accordance with at least one embodiment, a communications satellite system is provided that comprises a communications satellite, at least one user terminal and at least one gateway terminal. The communications satellite includes a receiver subsystem and a transmitter subsystem, and provides a forward communication path and a return communication path between the user terminal and the gateway terminal. At least one equivalent signal component having substantially the same operating range for at least one operating characteristic is included in the forward and return communication paths. Operating characteristics may include bandwidth, gain, frequency range, center frequency, and local oscillator frequency. Typically, the equivalent signal component includes at least one low noise amplifier, a downconverter, and a transmission amplifier. Alternatively, the communications satellite system includes at least one of a single downconverter, a single low noise amplifier, a single transmission amplifier, and a single orthomode transducer operating in both forward and return communication paths.

This invention is useful in a satellite communication system as the invention reduces cost and increases efficiency by utilizing equivalent, substantially similar, or shared components. By using equivalent components, the design cost of the system is decreased. The cost of the system may be further reduced by using shared components. By sharing components, the total number of components on the satellite is reduced, thus less components need to be purchased. Additionally, the mass of the payload is decreased, resulting in decreased launch costs.

### BRIEF DESCRIPTION OF THE DRAWINGS

FIG. 1 illustrates a communications satellite system utilizing equivalent signal components according to an embodiment of the present invention.

FIG. 2 illustrates a forward communication path according to an embodiment of the present invention.

FIG. 3 illustrates a return communication path according to an embodiment of the present invention.

FIG. 4 illustrates a communications satellite system utilizing single components according to an embodiment of the present invention.

The foregoing summary, as well as the following detailed description of the embodiments of the present invention, will be better understood when read in conjunction with the appended drawings. It should be understood, however, that the present invention is not limited to the arrangements and instrumentality shown in the attached drawings.

### DETAILED DESCRIPTION OF THE EMBODIMENTS

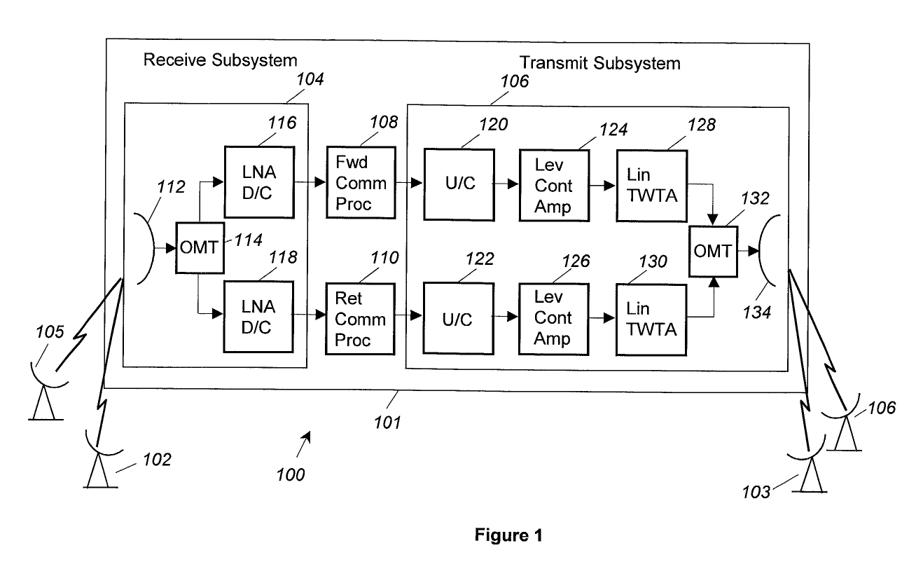

FIG. 1 illustrates a communications satellite system 100 utilizing equivalent signal components according to an embodiment of the present invention. The communications satellite system 100 includes a satellite 101 and ground terminals 102, 103, 105, and 107. The satellite 101 comprises a receiver subsystem 104, a transmitter subsystem 106, a forward communications processor 108, and a return communications processor 110. The receiver subsystem 104 includes an antenna 112, an orthomode transducer 114, and low noise amplifiers/downconverters (LNA D/C) 116 and 118. The transmitter subsystem 106 includes upconverters (U/C) 120 and 122, level controlling amplifiers 124 and 126, and transmission amplifiers 128 and 130. The transmission amplifiers 128 and 130 may be linearized traveling wave tube amplifiers (linearized TWTA) or solid state power amplifiers (SSPA), for example. The transmitter subsystem 106 further includes an orthomode transducer 132 and an antenna 134.

The communications satellite system 100 transmits signals between ground terminals 102, 103, 105, and 107. Ground terminals 102 and 103 represent gateway terminals, and terminals 105 and 107 represent user terminals. Although not illustrated in FIG. 1, there may be multiple user and gateway terminals 102 and 105 transmitting to antenna 112 and multiple user and gateway terminals 103 and 107 receiving from antenna 134.

In FIG. 1, the antenna 112 receives a forward communication signal from gateway terminal 102 and a return communication signal from user terminal 105. The forward communication signal sent from the gateway terminal 102 is a wideband signal comprised of a high volume of information that will be separated and transmitted to at least one user terminal 107. The return communication signal transmitted from user terminal 105 is combined with other return signals from other user terminals 105 and transmitted to a gateway terminal 103. By way of example, the forward communication signal may occupy a subset of the 29-29.5 GHz band, and the return communication signal may occupy a subset of the 29.5-30 GHz band. The forward and return communication signals may be polarized opposite one another.

The antenna 112 feeds the polarized forward and return communication signals to the orthomode transducer 114. The orthomode transducer 114 separates the forward and return communication signals based on the directions of polarization. The forward communication signal is sent to the LNA D/C 116 and the return communication signal is sent to the LNA D/C 118. The LNA circuitry of the LNA D/C 116 and LNA D/C 118 amplifies the communication signals and the D/C circuitry downconverts the communication signal to a lower processing frequency by multiplying the communication signal by a local oscillator frequency. For example, if the local oscillator frequency is 25 GHz, and if the forward communication signal has a center frequency at 29 GHz, then the center frequency output by the LNA D/C 116 would be 4 GHz.

Optionally, the LNA D/C 116 and LNA D/C 118 may be preceded by at least one filter (not shown). In addition, the LNA D/C 116 and LNA D/C 118 may be followed by at least one image rejection filter (not shown) to remove the unwanted frequency component created by the D/C circuitry.

The components and electrical operation characteristics of the LNA D/C 116 are constructed to be substantially equivalent to the components and electrical operating characteristics of the LNA D/C 118. That is, the LNA D/C 116 and the LNA D/C 118 have substantially the same operating range and operating characteristics and are interchangeable. For example, the low noise amplifier circuitry of the LNA D/C 116 and LNA D/C 118 may have the same gain, bandwidth and center frequency. Consequently, the bandwidth of the LNA D/C 116 and the bandwidth of the LNA D/C 118 would both be wide enough to cover the operating frequency ranges of both the forward and return communication signals. Continuing the example above, the LNA D/C 116 and LNA D/C 118 would have a bandwidth of at least 1 GHz to accommodate signals transmitted from 29-30 GHz. In addition, the D/C circuitry of the LNA D/C 116 and LNA D/C 118 may have the same operating band and local oscillator frequency. Alternatively, the local oscillator frequency of the D/C circuitry of the LNA D/C 116 and 118 may be different. If the local oscillator frequency of the LNA D/C 116 is different from the local oscillator frequency of the LNA D/C 118, it is possible that the processing frequencies may be equivalent for both the forward and return communication signals.

In FIG. 1, the LNA and the D/C components are illustrated as one unit. However, the LNA and the D/C components may be separate units. Independent of whether the LNA and D/C components are a single unit or separate units, the LNA and the D/C components used to process the forward communication signal are equivalent to the LNA and D/C components used to process the return communication signal.

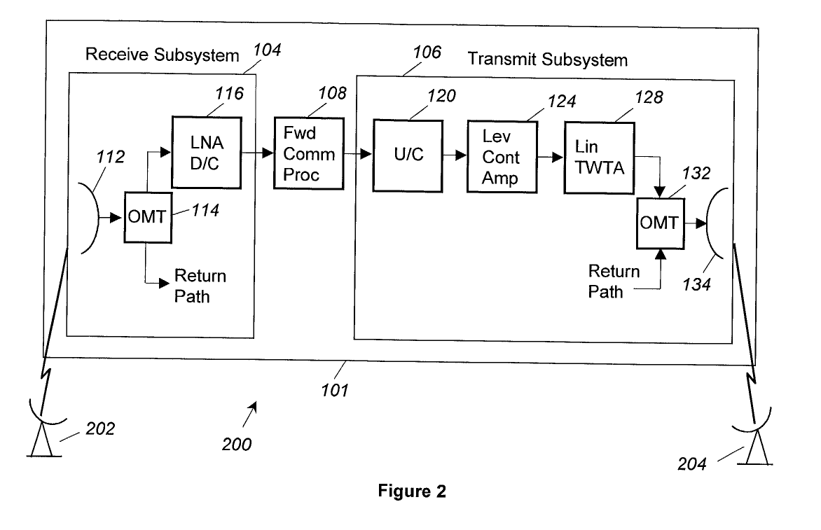

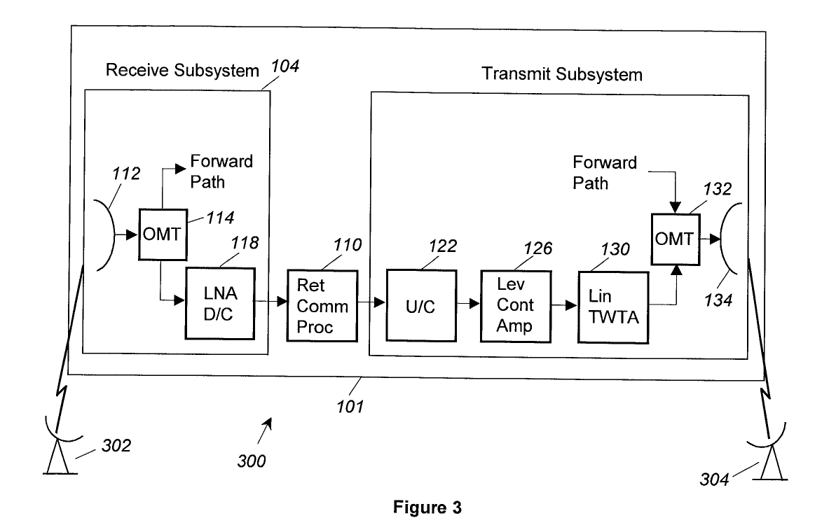

The output of the LNA D/C 116 is sent to the forward communications processor 108, and the output of the LNA D/C 118 is sent to the return communications processor 110. The forward communications processor 108 and the return communications processor 110 will be discussed further in reference to FIGS. 2 and 3.

The output of the forward communications processor 108 is sent to the input of the U/C 120, and the output of the return communications processor 110 is sent to the input of the U/C 122. The U/C 120 and U/C 122 convert the communication signals from the processing frequency to transmission frequencies for the forward and return communication paths. For example, if the processing frequency of the forward communication signal is 4 GHz, the U/C 120 may convert the signal to a transmission frequency of 20 GHz.

In the embodiment of FIG. 1, the components and electrical operating characteristics of the U/C 120 are constructed to be substantially equivalent to the components and electrical operating characteristics of the U/C 122. That is, the U/C 120 and U/C 122 have substantially the same operating range and operating characteristics, and no change in circuit operation would result from interchanging U/C 120 and U/C 122. For example, the frequency of the local oscillator, and the center frequency and the operating band of the mixer are the same for U/C 120 and U/C 122. Alternatively, the U/C 120 and U/C 122 may have different local oscillator frequencies. Different local oscillator frequencies may be necessary to achieve the desired transmission frequency if the same intermediate frequency is used for both forward and return processing.

Optionally, at least one image rejection filter (not shown) may process the output of U/C 120 and U/C 122. The image rejection filter may remove any unwanted frequency component present after the mixing of the communication signals with the local oscillator frequency.

The output of the U/C 120 is sent to the input of the level controlling amplifier 124 and the output of the U/C 122 is sent to the input of the level controlling amplifier 126. The level controlling amplifiers 124 and 126 adjust the gain of the communication signal to compensate for the distortions caused by the transmission amplifiers 128 and 130. In FIG. 1, the components and electrical operating characteristics of the level controlling amplifier 124 are equivalent to the components and electrical operating characteristics of the level controlling amplifier 126. Thus, no change in circuit operation would result from interchanging level controlling amplifiers 124 and 126. For example, the level controlling amplifiers 124 and 126 may have the same dynamic range.

The output of the level controlling amplifier 124 is sent to the input of the transmission amplifier 128 and the output of the level controlling amplifier 126 is sent to the input of the transmission amplifier 130. The transmission amplifiers 128 and 130 amplify the communication signals. In the embodiment of FIG. 1, the transmission amplifier 128 is equivalent to the transmission amplifier 130. That is, the transmission amplifiers 128 and 130 have the same operating range and operating characteristics. For example, the transmission amplifiers 128 and 130 may have the same power-in vs. power-out characteristic, bandwidth, and center frequency, and thus are interchangeable.

The outputs of the transmission amplifiers 128 and 130 are combined by the orthomode transducer 132. The orthomode transducer 132 polarizes the forward and return communication signals and sends the combined signal to the antenna 134. The antenna 134 transmits the signal to one or more gateway terminals 103 and user terminals 107.

FIGS. 2 and 3 illustrate the paths of the forward and return communication signals of the communications satellite system 100. Previously discussed elements of FIG. 1 are denoted with the same reference numbers.

FIG. 2 illustrates a forward communication path 200 according to an embodiment of the present invention. The forward communication path 200 comprises a satellite 101, a gateway terminal 202 and a user terminal 204. FIG. 3 illustrates a return communication path 300 according to an embodiment of the present invention. The return communication path 300 comprises a satellite 101, a user terminal 302 and a gateway terminal 304. For clarity, FIGS. 2 and 3 will be discussed at the same time.

The forward communication path 200 and the return communication path 300 of satellite 101 include equivalent components and shared components, with the exception of the forward communications processor 108 and the return communications processor 110. Equivalent components, as discussed in FIG. 1, are the LNA D/Cs 116 and 118, the U/Cs 120 and 122, the level controlling amplifiers 124 and 126, and the transmission amplifiers 128 and 130. The shared components are the antennas 112 and 134, and the orthomode transducers 114 and 132.

The utilization of system components that are equivalent or substantially similar focuses on commonality and the ability to utilize the same basic design in both the forward and return communication directions. This commonality may reduce cost and increase efficiency by promoting the ability to utilize components in multiple locations, while not compromising the quality of service provided.

In FIG. 2, the forward communications signal sent from the gateway terminal 202 to the user terminal 204 takes the forward communication path 200. In FIG. 3, the return communications signal sent from the user terminal 302 to the gateway terminal 304 takes the return communication path 300. As previously described, the forward communication signal may be one wideband signal comprised of a high volume of information designated to be sent to many user terminals 204, while the return communications signal transmitted to the gateway terminal 304 may be comprised of a varying number of smaller bands containing a varying volume of information from multiple user terminals 302. For example, the gateway terminals 202 and 304 may be hubs and the user terminals 204 and 302 may be very small aperture terminals (VSAT).

The forward communications signal sent from gateway terminal 202 and the return communications signal sent from user terminal 302 are received at antenna 112 simultaneously. The forward and return communication signals may be polarized orthogonally. Independent of polarization, the forward and return communication signals may also occupy separate frequency bands. The received signals are sent to the orthomode transducer 114. The orthomode transducer 114 separates the signals. The forward communication signal is sent to LNA D/C 116 as indicated in FIG. 2, while the return communication signal is sent to LNA D/C 118 as indicated in FIG. 3.

The LNA D/C 116 and LNA D/C 118 process the signals as discussed previously.

Next, the forward communications processor 108 receives the forward communication signal from the LNA D/C 116. The forward communications processor 108 utilizes a frequency demultiplexor to separate the forward communication signal from the gateway terminal 202 into subbands. Each subband may contain information for multiple user terminals 204.

The return communications processor 110 receives the return communication signal from the LNA D/C 118. The return communications processor 110 utilizes a frequency multiplexor to combine the return communication signal from the multiple user terminals 302 into one band to be transmitted to the gateway terminal 304.

If the LNA D/C 116 and LNA D/C 118 are equivalent except for having different local oscillator frequencies, the forward communications processor 108 and the return communications processor 110 may be designed to process communication signals that have been downconverted to the same processing frequency. If the LNA D/C 116 and LNA D/C 118 are equivalent and have the same local oscillator frequencies, then the communication signals that have been downconverted will have different processing frequencies.

As discussed in reference to FIGS. 1, 2, and 3, the utilization of equivalent, substantially similar, or shared components may reduce cost and increase efficiency. The communications satellite system 400 introduces additional efficiencies by utilizing more shared components, thus decreasing the number of unique components. Decreasing the number of unique components decreases the design cost and risk of the communications satellite system. Reducing the total number of components on the satellite reduces cost, as less components would be purchased and launch costs decrease as the mass of the payload decreases. In addition, a reduction in required power would result from reducing the total number of components, without negatively impacting the quality of service.

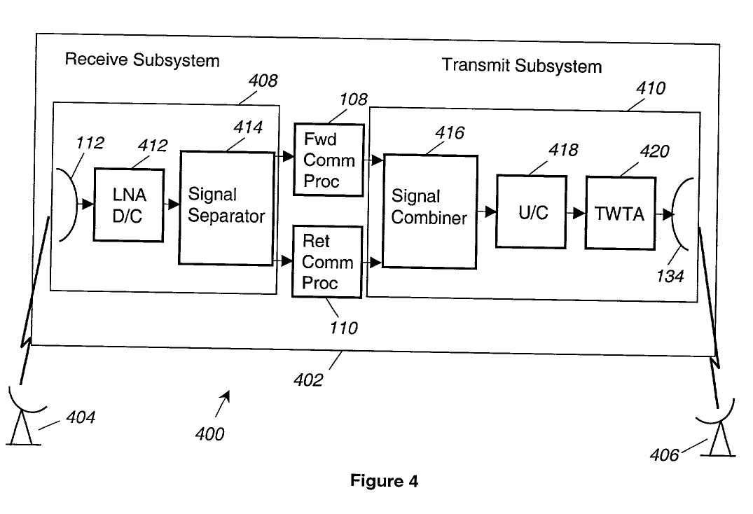

FIG. 4 illustrates a communications satellite system 400 utilizing single components according to an embodiment of the present invention. The communications satellite system 400 includes a satellite 402 and ground terminals 404 and 406. The satellite comprises a receiver subsystem 408, a transmitter subsystem 410, a forward communications processor 108 and a return communications processor 110. The receiver subsystem 408 includes an antenna 112, a LNA D/C 412, and a signal separator 414. The transmitter subsystem 410 includes a signal combiner 416, an U/C 418, a transmission amplifier 420, and an antenna 134.

Although multiple gateway terminals and user terminals are not illustrated in FIG. 4, the ground terminals 404 and 406 may be either gateway terminals or user terminals, or a combination of gateway and user terminals, as previously discussed. Thus, it is possible that the signal received at antenna 112 contains information transmitted from both gateway and user terminals. In FIG. 4, the forward communication signal transmitted from one or more gateway terminals and the return communication signal transmitted from one or more user terminals are transmitted utilizing frequency division multiple access (FDMA), time division multiple access (TDMA) or code division multiple access (CDMA). Alternatively, the forward and return communication signals may be transmitted utilizing a combination of one or more FDMA, TDMA and CDMA.

The forward and return communication signals are transmitted from at least one ground terminal 404. The forward and return communication signals are received simultaneously by antenna 112. Antenna 112 sends the communication signals to the LNA D/C 412. The LNA D/C 412 processes signals in the same manner as discussed previously for LNA D/Cs 116 and 118. In the embodiment of FIG. 4, however, only one LNA D/C 412 is needed to process both the forward and return communication signals.

The LNA D/C 412 sends the communication signals to the signal separator 414. The signal separator 414 comprises the FDMA, TDMA or CDMA circuitry required to separate the forward and return communication signals. For example, if the forward and return communication signals are transmitted utilizing FDMA, the signal separator 414 may include at least one bandpass filter and frequency tuner.

After the communication signals are separated, the forward communication signal is sent to the forward communications processor 108 and the return communication signal is sent to the return communications processor 110. The forward communications processor 108 and the return communications processor 110 process the communications signals as previously discussed.

The processed signals are then sent to the signal combiner 416. The signal combiner 416 combines the processed forward and return communication signals utilizing one or more of FDMA, TDMA, or CDMA. The combined signal is sent to the U/C 418, then the transmission amplifier 420, and finally the antenna 134 to be transmitted to the ground terminal 406. In FIG. 4, only one U/C 418 and one transmission amplifier 420 are used to process the forward and return communication signals.

In an alternative embodiment (not shown), the antenna 112 first sends the received communication signals to the signal separator 414. The signal separator 414 sends the forward communication signal to one LNA D/C and the return communication signal to an equivalent LNA D/C. Therefore, the LNA D/C 412 is replaced by two equivalent LNA D/C components. As previously discussed, the two LNA D/C components are identical, with the exception of having two different oscillator frequencies.

While the invention has been described with reference to at least one embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A communications satellite system, comprising:
at least one user terminal;
at least one gateway terminal;
a communications satellite for conveying communication signals between said user terminal and said gateway terminal;
a forward communication path between said user terminal and said gateway terminal through said communications satellite;
a return communication path between said user terminal and said gateway terminal through said communications satellite;
at least one equivalent signal component, located in both said forward and return communication paths, for operating upon said communication signals; and
said equivalent signal component having substantially the same operating range in both said forward and return communication paths for at least one operating characteristic.

2. The communications satellite system of claim 1, wherein said equivalent signal component includes at least one of a low noise amplifier, a downconverter, and a transmission amplifier in each of said forward and return communication paths.

3. The communications satellite system of claim 1, wherein said equivalent signal components include a low noise amplifier in each of said forward and return communication paths; and
wherein said range for said operating characteristic of said low noise amplifiers includes the same bandwidth and center frequency.

4. The communications satellite system of claim 1, wherein said equivalent signal components include a downconverter in each of said forward and return communication paths; and
wherein said range for said operating characteristic of said downconverter includes the same operating band and local oscillator frequency.

5. The communications satellite system of claim 1, wherein said equivalent signal components include an upconverter in each of said forward and return communication paths; and
wherein said range for said operating characteristic of said upconverter includes the same operating band and local oscillator frequency.

6. The communications satellite system of claim 1, wherein said range has at least one of common minimum and maximum level for said equivalent signal components in said forward and return communication paths.

7. The communications satellite system of claim 1, wherein said range constitutes substantially identical bandwidth for said equivalent signal components in said forward and return communication paths.

8. The communications satellite system of claim 1, wherein said range constitutes substantially identical gain for said equivalent signal components in said forward and return communication paths.

9. The communications satellite system of claim 1, wherein said range constitutes substantially identical frequency range for said equivalent signal components in said forward and return communication paths.

10. The communications satellite system of claim 1, wherein said range constitutes substantially identical center frequency for said equivalent signal components in said forward and return communication paths.

11. The communications satellite system of claim 1, wherein said equivalent signal component includes a single downconverter operating in both said forward and return communication paths.

12. The communications satellite system of claim 1, wherein said equivalent signal component includes a single low noise amplifier operating in both said forward and return communication paths.

13. The communications satellite system of claim 1, wherein said equivalent signal component includes a single orthomode transducer operating in both said forward and return communication paths.

14. In a communications satellite, a receiver subsystem comprising:
an input lead for accepting a first communication signal for a forward communication path and a second communication signal for a return communication path;
at least one equivalent signal component having a single operating range in both said forward and return communication paths for at least one parameter of said equivalent signal component; and
said equivalent signal component including at least one of a low noise amplifier and a downconverter.

15. The receiver subsystem of claim 14 wherein said equivalent signal component includes said low noise amplifier in each of said forward and return communication paths; and
wherein said range for said parameter of said low noise amplifiers includes the same bandwidth and center frequency.

16. The receiver subsystem of claim 14, wherein said equivalent signal component includes said downconverter in each of said forward and return communication paths; and
wherein said range for said parameter of said downconverter includes the same operating band and local oscillator frequency.

17. The receiver subsystem of claim 14, wherein said equivalent signal component includes a single said downconverter operating in both said forward and return communication paths.

18. The receiver subsystem of claim 14, wherein said equivalent signal component includes a single said low noise amplifier operating in both said forward and return communication paths.

19. In a communications satellite, a transmitter subsystem comprising:
an output lead for outputting a first communication signal for a forward communication path and a second communication signal for a return communication path;
at least one equivalent signal component having a single operating range in both said forward and return communication paths for at least one parameter of said equivalent signal component; and
said equivalent signal component including at least one of an upconverter and a transmission amplifier.

20. The transmitter subsystem of claim 19, wherein said equivalent signal component includes said upconverter in each of said forward and return communication paths; and
wherein said range for said parameter of said upconverter includes the same operating band and local oscillator frequency.

21. The transmitter subsystem of claim 19, wherein said range constitutes substantially identical bandwidth for said equivalent signal components in said forward and return communication paths.

22. The transmitter subsystem of claim 19, wherein said range constitutes substantially identical frequency range for said equivalent signal components in said forward and return communication paths.

23. A communications satellite, comprising:
an antenna receiving communication signals from at least one user terminal and at least one gateway terminal;
a forward communication path between said user terminal and said gateway terminal through said communications satellite;
a return communication path between said user terminal and said gateway terminal through said communications satellite;
at least one equivalent signal component, located in both said forward and return communication paths, for operating upon said communication signals; and
said equivalent signal component having substantially the same operating range in both said forward and return communication paths for at least one operating characteristic.

24. The communications satellite of claim 23, wherein said equivalent signal component includes a low noise amplifier in each of said forward and return communication paths; and
wherein said range for said operating characteristic of said low noise amplifiers includes the same bandwidth and center frequency.

25. The communications satellite of claim 23, wherein said equivalent signal component includes a downconverter in each of said forward and return communication paths; and
wherein said range for said operating characteristic of said downconverter includes the same operating band and local oscillator frequency.

26. The communications satellite of claim 23, wherein said equivalent signal component includes an upconverter in each of said forward and return communication paths; and
wherein said range for said operating characteristic of said upconverter includes the same operating band and local oscillator frequency.

27. The communications satellite of claim 23, wherein said range constitutes substantially identical gain for said equivalent signal components in said forward and return communication paths.

28. The communications satellite of claim 23, wherein said range constitutes substantially identical frequency range for said equivalent signal components in said forward and return communication paths.

29. The communications satellite of claim 23, wherein said equivalent signal component includes a single downconverter operating in both said forward and return communication paths.

30. The communications satellite of claim 23, wherein said equivalent signal component includes a single low noise amplifier operating in both said forward and return communication paths.
